(19) United States
(12) Patent Application Publication
(10) Pub. No.: US 2025/0228294 A1
(43) Pub. Date: Jul. 17, 2025

(54) AEROSOL-GENERATING SYSTEM AND AEROSOL-GENERATING ARTICLE

(71) Applicant: KT&G CORPORATION, Daejeon (KR)

(72) Inventors: Chul Ho JANG, Daejeon (KR); Gyoung Min GO, Daejeon (KR); Hyung Jin BAE, Daejeon (KR); Jangwon SEO, Daejeon (KR); Jong Seong JEONG, Daejeon (KR); Jinchul JUNG, Daejeon (KR)

(73) Assignee: KT&G CORPORATION, Daejeon (KR)

(21) Appl. No.: 18/854,164

(22) PCT Filed: Jun. 2, 2023
(86) PCT No.: PCT/KR2023/007579

§ 371 Date: Oct. 4, 2024

(30) Foreign Application Priority Data
Aug. 25, 2022 (KR) 10-2022-0106850

(51) Int. Cl. A24F 40/42; A24F 40/465; A24F 40/485; H05B 6/10

(52) U.S. Cl. CPC A24F 40/42; A24F 40/465; A24F 40/485; H05B 6/108

(57) ABSTRACT

An aerosol-generating system according to various embodiments includes an aerosol-generating device, and an aerosol-generating article accommodated in the medium accommodation portion. The aerosol generating device includes a housing including a first housing end and a second housing end on a side opposite to the first housing end, an external air inflow unit detachably coupled to the first housing end of the housing, a medium accommodation portion disposed in the housing and including a first wall and a second wall facing the first wall, a heating unit disposed outside the first wall and the second wall of the medium accommodation portion and configured to heat the aerosol generating article accommodated in the medium accommodation portion, and an airflow path tube fluidly connecting the medium accommodation portion and the second housing end of the housing, and the external air inflow unit includes a perforation that causes an external fluid of the aerosol generating device to flow into the inside of the aerosol generating device.

### TECHNICAL FIELD

The following embodiments relate to an aerosol generating system and an aerosol generating article.

### BACKGROUND ART

Recently, demands for alternative articles to overcome disadvantages of general cigarettes have increased. For example, there is an increasing demand for a device (e.g., a cigarette-type electronic cigarette) that generates an aerosol by electrically heating a cigarette stick. Accordingly, research on an electrically heated aerosol generating device and a cigarette stick (or an aerosol generating article) applied thereto is being actively conducted. For example, Korean Patent Application Publication No. 10-2017-0132823 discloses a non-combustion-type flavor inhaler, a flavor inhalation component source unit, and an atomizing unit.

### DISCLOSURE OF THE INVENTION

### Technical Goals

An object according to an embodiment is to provide an aerosol generating system for cooling an aerosol generated inside a device by introduced external air to have a large amount of atomization.

Another object according to an embodiment is to provide an aerosol generating article that may be used as a medium for both chewing tobacco and heated tobacco.

### Technical Solutions

An aerosol generating system according to various embodiments includes an aerosol generating device, and an aerosol generating article accommodated in the medium accommodation portion. The aerosol generating device includes a housing including a first housing end and a second housing end on a side opposite to the first housing end, an external air inflow unit detachably coupled to the first housing end of the housing, a medium accommodation portion disposed in the housing and including a first wall and a second wall facing the first wall, a heating unit disposed outside the first wall and the second wall of the medium accommodation portion and configured to heat the aerosol generating article accommodated in the medium accommodation portion, and an airflow path tube fluidly connecting the medium accommodation portion and the second housing end of the housing, and the external air inflow unit includes a perforation that causes an external fluid of the aerosol generating device to flow into the inside of the aerosol generating device.

In an embodiment, the aerosol generating article may include a medium portion, and an outer cover portion that covers outer surfaces of the medium accommodation portion, and may include a first surface that contacts with an inner surface of the first wall and a second surface that contacts with an inner surface of the second wall when the aerosol generating article is accommodated in the medium accommodation portion.

In an embodiment, the heating unit may further include a susceptor surrounding at least two surfaces of the medium accommodation portion, and an induction coil that induces a variable magnetic field to the susceptor.

In an embodiment, the heating unit may be configured to contact with an outer surface of the first wall and an outer surface of the second wall of the medium accommodation portion to directly heat the aerosol generating article accommodated in the medium accommodation portion.

In an embodiment, a width between the first wall and the second wall of the medium accommodation portion of the aerosol generating device may be smaller than or equal to a width between the first surface and the second surface of the aerosol generating article.

In an embodiment, the external air inflow unit may further include a mouthpiece unit, and the aerosol generating device includes a first airflow path fluidly connecting the mouthpiece unit and the medium accommodation portion, and a second airflow path fluidly connecting the first airflow path and the outside of the aerosol generating device.

In an embodiment, the external air inflow unit may reduce a temperature of an aerosol as a fluid introduced through the perforation moves along the second airflow path when a user inhales through the mouthpiece unit.

An aerosol generating article according to various embodiments includes a first surface, a second surface formed on a side opposite to the first surface, and one or more side surfaces perpendicular to the first surface and the second surface, a medium portion including a first medium surface, a second medium surface formed on a side opposite to the first medium surface, and one or more medium side surfaces perpendicular to the first medium surface and the second medium surface, and an outer cover portion covering the first medium surface, the second medium surface, and the medium side surfaces of the medium portion and formed of a porous material. The aerosol generating article may be selectively transferred by a method in which the aerosol generating article is inserted into the medium accommodation portion of the aerosol generating device of claim 1 to be transferred through an aerosol generated by heating or a method in which the aerosol generating article is inserted into user's mouth to be directly transferred.

In an embodiment, the first surface and the second surface of the aerosol generating article may have the same shape and area.

In an embodiment, each area of the first surface and the second surface may be larger than an area of the side surface.

### Effects

The aerosol generating system according to an embodiment may cool an aerosol generated inside a device by introduced external air to obtain a sufficient atomization amount.

The aerosol generating article according to an embodiment may be used as a medium for chewing tobacco or heated tobacco.

The effects of the aerosol generating system and the aerosol generating article according to an embodiment are not limited to the above-mentioned effects, and other unmentioned effects may be clearly understood from the following description by one of ordinary skill in the art.

### BRIEF DESCRIPTION OF DRAWINGS

FIG. 1 is a block diagram of an aerosol generating device according to an embodiment.

FIG. 2A is a perspective view of an aerosol generating system according to an embodiment.

FIG. 2B is a cross-sectional view of an aerosol generating system according to an embodiment.

FIG. 2C is an exploded perspective view of an aerosol generating system according to an embodiment.

FIG. 3 is a cross-sectional view of an aerosol generating system according to an embodiment.

FIG. 4A is a perspective view of an aerosol generating article according to an embodiment.

FIG. 4B is a cross-sectional view of an aerosol generating article according to an embodiment.

### BEST MODE FOR CARRYING OUT THE INVENTION

The terms used in the embodiments are selected from among common terms that are currently widely used, in consideration of their function in the disclosure. However, the terms may become different according to an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and which may be implemented as hardware, software, or a combination of hardware and software.

As used herein, an expression such as “at least one of” that precedes listed components modifies not each of the listed components but all the listed components. For example, the expression “at least one of a, b, or c” should be construed as including a, b, c, a and b, a and c, b and c, or a, b, and c.

In the following embodiments, the term “aerosol generating article” may refer to an article that accommodates a medium, in which an aerosol passes through the article and the medium is transferred. A representative example of the aerosol generating article may be a cigarette. However, the scope of the disclosure is not limited thereto.

In the following embodiments, the term “upstream” or “upstream direction” may refer to a direction away from an oral region of a user (smoker), and the term “downstream” or “downstream direction” may refer to a direction approaching the oral region of the user. The terms “upstream” and “downstream” may be used to describe relative positions of components of an aerosol generating article.

In the following embodiments, the term “puff” refers to inhalation by a user, and the inhalation refers to a situation in which a user draws in an aerosol into his or her oral cavity, nasal cavity, or lungs through the mouth or nose.

In an embodiment, an aerosol generating device may be a device that generates an aerosol by electrically heating an aerosol generating article accommodated in an inner space.

The aerosol generating device may include a heater. In an embodiment, the heater may be an electrically resistive heater. For example, the heater may include an electrically conductive track, and the heater may be heated as a current flows through the electrically conductive track.

The heater may include a tubular heating element, a plate-shaped heating element, a needle-shaped heating element, or a rod-shaped heating element, and may heat the inside or outside of the aerosol generating article according to the shape of a heating element.

The aerosol generating article may include a tobacco rod and a filter rod. The tobacco rod may be formed as a sheet or a strand, or may be formed of tobacco leaves finely cut from a tobacco sheet. In addition, the tobacco rod may be enveloped by a thermally conductive material. For example, the thermally conductive material may be metal foil such as aluminum foil. However, embodiments are not limited thereto.

The filter rod may be a cellulose acetate filter. The filter rod may include at least one segment. For example, the filter rod may include a first segment that cools an aerosol and a second segment that filters a predetermined ingredient contained in the aerosol.

In another embodiment, the aerosol generating device may be a device that generates an aerosol using a cartridge containing an aerosol generating material.

The aerosol generating device may include a cartridge containing the aerosol generating material and a main body supporting the cartridge. The cartridge may be detachably coupled to the main body. However, embodiments are not limited thereto. The cartridge may be integrally formed or assembled with the main body, and may be secured to the main body so as not to be detached by a user. The cartridge may be mounted on the main body while the aerosol generating material is accommodated therein. However, embodiments are not limited thereto. The aerosol generating material may be injected into the cartridge while the cartridge is coupled to the main body.

The cartridge may hold the aerosol generating material in any one of various states, such as a liquid state, a solid state, a gaseous state, and a gel state. The aerosol generating material may include a liquid composition. For example, the liquid composition may be a liquid including a tobacco-containing material having a volatile tobacco flavor component, or may be a liquid including a non-tobacco material.

The cartridge may be operated by an electrical signal or a wireless signal transmitted from the main body to perform the function of generating an aerosol by converting a phase of the aerosol generating material inside the cartridge to a gaseous phase. The aerosol may refer to a gas in which vaporized particles generated from the aerosol generating material are mixed with air.

In another embodiment, the aerosol generating device may generate an aerosol by heating the liquid composition, and the generated aerosol may pass through the cigarette and be delivered to the user. That is, the aerosol generated from the liquid composition may travel along an airflow path of the aerosol generating device, and the airflow path may be configured to allow the aerosol to pass through the cigarette and be delivered to the user.

In another embodiment, the aerosol generating device may be a device that generates an aerosol from the aerosol generating material using an ultrasonic vibration manner. In this case, the ultrasonic vibration manner may refer to a manner of generating an aerosol by atomizing the aerosol generating material with ultrasonic vibration generated by a vibrator.

The aerosol generating device may include a vibrator, and may generate vibration at short intervals through the vibrator to atomize the aerosol generating material. The vibration generated by the vibrator may be ultrasonic vibration, and a frequency band of the ultrasonic vibration may be from about 100 kilohertz (kHz) to about 3.5 megahertz (MHz). However, embodiments are not limited thereto.

The aerosol generating device may further include a wick that absorbs the aerosol generating material. For example, the wick may be disposed to surround at least one area of the vibrator or may be disposed to contact at least one area of the vibrator.

As a voltage (e.g., an alternating voltage) is applied to the vibrator, the vibrator may generate heat and/or ultrasonic vibration, and the heat and/or ultrasonic vibration generated by the vibrator may be transmitted to the aerosol generating material absorbed in the wick. The aerosol generating material absorbed in the wick may be converted into a gas phase by the heat and/or ultrasonic vibration transmitted from the vibrator, and consequently, an aerosol may be generated.

For example, the viscosity of the aerosol generating material absorbed in the wick may be lowered by the heat generated by the vibrator, and the aerosol generating material whose viscosity is lowered may change to fine particles by the ultrasonic vibration generated by the vibrator, so that an aerosol may be generated. However, embodiments are not limited thereto.

In another embodiment, the aerosol generating device may be a device that generates an aerosol by heating the aerosol generating article accommodated therein in an induction heating manner.

The aerosol generating device may include a susceptor and a coil. In an embodiment, the coil may apply a magnetic field to the susceptor. As the aerosol generating device supplies power to the coil, a magnetic field may be formed inside the coil. In an embodiment, the susceptor may be a magnetic body that generates heat by an external magnetic field. As the susceptor is positioned inside the coil and generates heat with the magnetic field applied, the aerosol generating article may be heated. Also, optionally, the susceptor may be positioned in the aerosol generating article.

In another embodiment, the aerosol generating device may further include a cradle.

The aerosol generating device and the separate cradle may form a system together. For example, the cradle may be used to charge a battery of the aerosol generating device. Alternatively, a heater may be heated when the cradle and the aerosol generating device are coupled to each other.

Hereinafter, embodiments of the disclosure will be described in detail with reference to the accompanying drawings such that one of ordinary skill in the art may easily practice the disclosure. The disclosure may be practiced in forms that are implementable in the aerosol generating devices according to various embodiments described above or may be embodied and practiced in many different forms and is not limited to the embodiments described herein.

Hereinafter, embodiments of the disclosure will be described in detail with reference to the drawings.

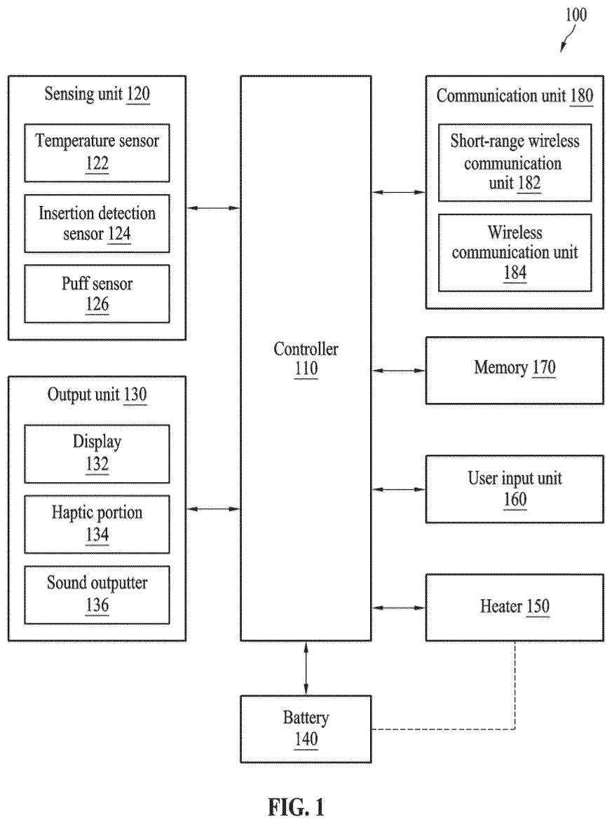

FIG. 1 is a block diagram of an aerosol generating device 100 according to an embodiment.

The aerosol generating device 100 may include a controller 110, a sensing unit 120, an output unit 130, a battery 140, a heater 150, a user input unit 160, a memory 170, and a communication unit 180. However, an internal structure of the aerosol generating device 100 is not limited to what is shown in FIG. 1. It is to be understood by one of ordinary skill in the art to which the disclosure pertains that some of the components shown in FIG. 1 may be omitted or new components may be added according to the design of the aerosol generating device 100.

The sensing unit 120 may sense a state of the aerosol generating device 100 or a state of an environment around the aerosol generating device 100, and transmit sensing information obtained through the sensing to the controller 110. Based on the sensing information, the controller 110 may control the aerosol generating device 100 to control operations of the heater 150, restrict smoking, determine whether an aerosol generating article (e.g., an aerosol generating article, a cartridge, etc.) is inserted, display a notification, and perform other functions.

The sensing unit 120 may include at least one of a temperature sensor 122, an insertion detection sensor 124, or a puff sensor 126. However, embodiments are not limited thereto.

The temperature sensor 122 may sense a temperature at which the heater 150 (or an aerosol generating material) is heated. The aerosol generating device 100 may include a separate temperature sensor for sensing the temperature of the heater 150, or the heater 150 itself may also function as a temperature sensor. Alternatively, the temperature sensor 122 may be arranged around the battery 140 to monitor a temperature of the battery 140.

The insertion detection sensor 124 may sense whether the aerosol generating article is inserted and/or removed. The insertion detection sensor 124 may include, for example, at least one of a film sensor, a pressure sensor, a light sensor, a resistive sensor, a capacitive sensor, an inductive sensor, or an infrared sensor, which may sense a signal change by the insertion and/or removal of the aerosol generating article.

The puff sensor 126 may sense a puff from a user based on various physical changes in an airflow path or airflow channel. For example, the puff sensor 126 may sense the puff from the user based on one of a temperature change, a flow change, a voltage change, and a pressure change.

The sensing unit 120 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 122 to 126 described above. A function of each sensor may be intuitively inferable from its name by one of ordinary skill in the art, and thus, a more detailed description thereof will be omitted here.

The output unit 130 may output information about the state of the aerosol generating device 100 and provide the information to the user. The output unit 130 may include at least one of a display 132, a haptic portion 134, or a sound outputter 136. However, embodiments are not limited thereto. When the display 132 and a touchpad are provided in a layered structure to form a touchscreen, the display 132 may be used as an input device in addition to an output device.

The display 132 may visually provide information about the aerosol generating device 100 to the user. The information about the aerosol generating device 100 may include, for example, a charging/discharging state of the battery 140 of the aerosol generating device 100, a preheating state of the heater 150, an insertion/removal state of the aerosol generating article, a limited usage state (e.g., an abnormal article detected) of the aerosol generating device 100, or the like, and the display 132 may externally output the information. The display 132 may be, for example, a liquid-crystal display panel (LCD), an organic light-emitting display panel (OLED), or the like. The display 132 may also be in the form of a light-emitting diode (LED) device.

The haptic portion 134 may provide information about the aerosol generating device 100 to the user in a haptic way by converting an electrical signal into a mechanical stimulus or an electrical stimulus. The haptic portion 134 may include, for example, a motor, a piezoelectric element, or an electrical stimulation device.

The sound outputter 136 may provide information about the aerosol generating device 100 to the user in an auditory way. For example, the sound outputter 136 may convert an electrical signal into a sound signal and externally output the sound signal.

The battery 140 may supply power to be used to operate the aerosol generating device 100. The battery 140 may supply power to heat the heater 150. In addition, the battery 140 may supply power required for operations of the other components (e.g., the sensing unit 120, the output unit 130, the user input unit 160, the memory 170, and the communication unit 180) included in the aerosol generating device 100. The battery 140 may be a rechargeable battery or a disposable battery. The battery 140 may be, for example, a lithium polymer (LiPoly) battery. However, embodiments are not limited thereto.

The heater 150 may receive power from the battery 140 to heat the aerosol generating material. Although not shown in FIG. 1, the aerosol generating device 100 may further include a power conversion circuit (e.g., a direct current (DC)-to-DC (DC/DC) converter) that converts power of the battery 140 and supplies the power to the heater 150. In addition, when the aerosol generating device 100 generates an aerosol by induction heating, the aerosol generating device 100 may further include a DC-to-alternating current (AC) (DC/AC) converter that converts DC power of the battery 140 into AC power.

The controller 110, the sensing unit 120, the output unit 130, the user input unit 160, the memory 170, and the communication unit 180 may receive power from the battery 140 to perform functions. Although not shown in FIG. 1, the aerosol generating device 100 may further include a power conversion circuit, for example, a low dropout (LDO) circuit or a voltage regulator circuit, which converts power of the battery 140 and supplies the power to respective components.

In an embodiment, the heater 150 may be formed of a predetermined electrically resistive material that is suitable. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 150 may be implemented as a metal heating wire, a metal heating plate on which an electrically conductive track is arranged, a ceramic heating element, or the like. However, embodiments are not limited thereto.

In another embodiment, the heater 150 may be an induction heater. For example, the heater 150 may include a susceptor that heats the aerosol generating material by generating heat through a magnetic field applied by a coil.

In an embodiment, the heater 150 may include a plurality of heaters. For example, the heater 150 may include a first heater for heating the aerosol generating article and a second heater for heating a liquid.

The user input unit 160 may receive information input from the user or may output information to the user. For example, the user input unit 160 may include a key pad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 1, the aerosol generating device 100 may further include a connection interface such as a universal serial bus (USB) interface, and may be connected to another external device through the connection interface such as a USB interface to transmit and receive information or to charge the battery 140.

The memory 170, which is hardware for storing various pieces of data processed in the aerosol generating device 100, may store data processed by the controller 110 and data to be processed by the controller 110. The memory 170 may include at least one type of storage medium of flash memory-type memory, hard disk-type memory, multimedia card micro-type memory, card-type memory (e.g., secure digital (SD) or extreme digital (XD) memory), random access memory (RAM), static RAM (SRAM), read-only memory (ROM), electrically erasable programmable ROM (EEPROM), programmable ROM (PROM), magnetic memory, a magnetic disk, or an optical disk. The memory 170 may store an operating time of the aerosol generating device 100, a maximum number of puffs, a current number of puffs, at least one temperature profile, data associated with a smoking pattern of the user, or the like.

The communication unit 180 may include at least one component for communicating with another electronic device. For example, the communication unit 180 may include a short-range wireless communication unit 182 and a wireless communication unit 184.

The short-range wireless communication unit 182 may include a Bluetooth communication unit, a Bluetooth low energy (BLE) communication unit, a near field communication unit, a wireless local area network (WLAN) (wireless fidelity (Wi-Fi)) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communication unit 184 may include, for example, a cellular network communication unit, an Internet communication unit, a computer network (e.g., a LAN or wide-area network (WAN) communication unit, or the like. However, embodiments are not limited thereto. The wireless communication unit 184 may use subscriber information (e.g., international mobile subscriber identity (IMSI)) to identify and authenticate the aerosol generating device 100 in a communication network.

The controller 110 may control the overall operation of the aerosol generating device 100. In an embodiment, the controller 110 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the present disclosure pertains that it may be implemented in other types of hardware.

The controller 110 may control the temperature of the heater 150 by controlling supply of power from the battery 140 to the heater 150. For example, the controller 110 may control the supply of power by controlling switching of a switching element between the battery 140 and the heater 150. In another example, a direct heating circuit may control the supply of power to the heater 150 according to a control command from the controller 110.

The controller 110 may analyze a sensing result obtained by the sensing of the sensing unit 120 and control processes to be performed thereafter. For example, the controller 110 may control power to be supplied to the heater 150 to start or end an operation of the heater 150 based on the sensing result obtained by the sensing unit 120. In another example, the controller 110 may control an amount of power to be supplied to the heater 150 and a time for which the power is to be supplied, such that the heater 150 may be heated up to a predetermined temperature or maintained at a desired temperature, based on the sensing result obtained by the sensing unit 120.

The controller 110 may control the output unit 130 based on the sensing result obtained by the sensing unit 120. For example, when the number of puffs counted through the puff sensor 126 reaches a preset number, the controller 110 may inform the user that the aerosol generating device 100 is to be ended soon, through at least one of the display 132, the haptic portion 134, or the sound outputter 136.

In an embodiment, the controller 110 may control a power supply time and/or a power supply amount for the heater 150 according to a state of the aerosol generating article sensed by the sensing unit 120. For example, when the aerosol generating article is in an over-humidified state, the controller 110 may control the power supply time for an inductive coil to increase a preheating time, compared to a case where the aerosol generating article is in a general state.

An embodiment may be implemented in the form of a recording medium including instructions executable by a computer, such as a program module executable by the computer. A computer-readable medium may be any available medium that may be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

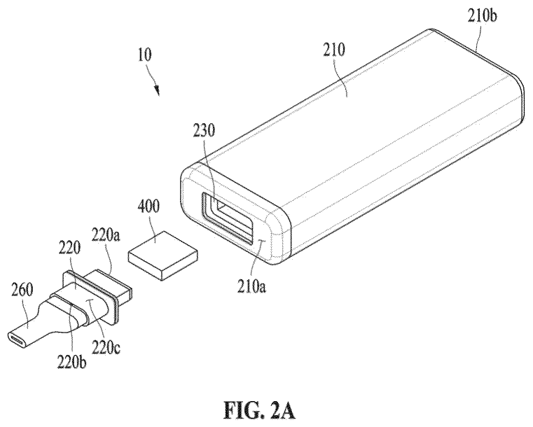

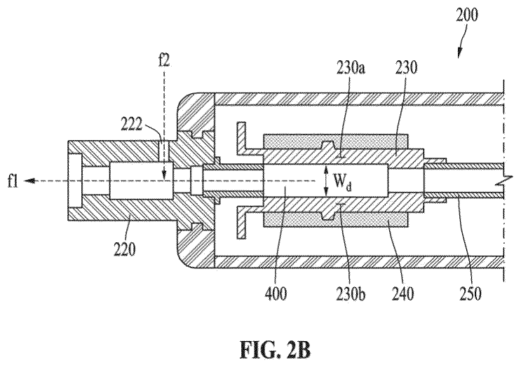

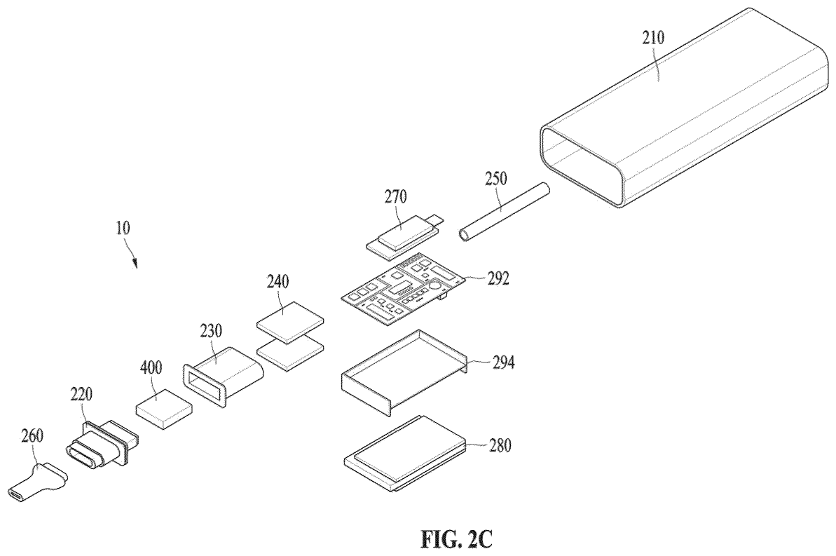

FIG. 2A is a perspective view of an aerosol generating system 10 according to an embodiment. FIG. 2B is a cross-sectional view of the aerosol generating system 10 according to an embodiment. FIG. 2C is an exploded perspective view of the aerosol generating system 10 according to an embodiment.

Referring to FIG. 2A, the aerosol generating system 10 may include an aerosol generating device 200 and an aerosol generating article 400. In an embodiment, the aerosol generating article 400 may be disposed inside the aerosol generating device 200. In an embodiment, the aerosol generating article 400 may be heated inside the aerosol generating device 200 to form an aerosol. Hereinafter, the configuration of the aerosol generating device 200 and the aerosol generating article 400 included in the aerosol generating system 10 will be described in detail.

Referring to FIGS. 2A to 2C, the aerosol generating device 200 may include a housing 210, an external air inflow unit 220, a medium accommodation portion 230, a heating unit 240, an airflow path tube 250, a mouthpiece unit 260, a display unit 270, a battery 280, and a controller 290.

The housing 210 according to an embodiment may include a first housing end 210a and a second housing end 210b. The first housing end 210a of the housing 210 may include a surface to be coupled to the external air inflow unit 220. The second housing end 210b of the housing 210 may be formed on a side opposite to the first housing end 210a.

The external air inflow unit 220 according to an embodiment may be coupled to the first housing end 210a of the housing 210. In an embodiment, the external air inflow unit 220 may be detachably coupled to the housing 210. In an embodiment, the external air inflow unit 220 may include a first inflow end 220a that comes into contact with the first housing end 210a of the housing 210, and a second inflow end 220b formed on a side opposite to the first inflow end 220a. In an embodiment, the external air inflow unit 220 may further include side inflow surfaces 220c formed between the first inflow end 220a and the second inflow end 220b. In an embodiment, the external air inflow unit 220 may include a perforation 222. In an embodiment, the perforation 222 may be formed in at least one of the side inflow surfaces 220c of the external air inflow unit 220. In an embodiment, an external fluid of the aerosol generating device 200 may flow into the aerosol generating device 200 through the perforation 222.

The medium accommodation portion 230 according to an embodiment may have a space in which the aerosol generating article 400 is accommodated. In an embodiment, the medium accommodation portion 230 may be disposed inside the housing 210. In an embodiment, the medium accommodation portion 230 may include a first wall 230a and a second wall 230b facing the first wall 230a. In an embodiment, the medium accommodation portion 230 may accommodate the aerosol generating article 400. In an embodiment, the aerosol generating article 400 accommodated inside the medium accommodation portion 230 may be accommodated to fit tight inside the medium accommodation portion 230.

The heating unit 240 according to an embodiment may heat the aerosol generating article 400 accommodated inside the medium accommodation portion 230. The aerosol generating article 400 heated by the heating unit 240 may form an aerosol. In an embodiment, the heating unit 240 may be disposed in contact with outer surfaces of the first wall 230a and the second wall 230b of the medium accommodation portion 230. In an embodiment, the heating unit 240 may be in contact with the outer surfaces of the first wall 230a and the second wall 230b of the medium accommodation portion 230 and directly heat the aerosol generating article accommodated in the medium accommodation portion 230 using conduction heat. In an embodiment, the heating unit 240 may be disposed in contact with the outer surfaces of the first wall 230a and the second wall 230b to minimize a loss of heat generated in the heating unit 240.

In an embodiment, the heating unit 240 may generate heat by methods such as conductive heating, inductive heating, convective heating, microwave heating, laser heating, optical heating, dielectric heating, etc. In an embodiment, the heat generation method of the heating unit 240 is not limited to the above examples and may further include a heating method that is conceivable by those skilled in the art.

The airflow path tube 250 according to an embodiment may fluidly connect the second end 210b of the housing 210 and the medium accommodation portion 230. In an embodiment, inhalation resistance that a user experiences when using the aerosol generating system 10 may be adjusted according to a length and width of the airflow path tube 250. As the length and width of the airflow path tube 250 are longer and narrower, the inhalation resistance may increase. As the length and width of the airflow path tube 250 are shorter and wider, the inhalation resistance may decrease. In an embodiment, the airflow path tube 250 may have a width narrower than a width Wd of the medium accommodation portion 230.

The mouthpiece unit 260 according to an embodiment may be disposed in contact with the second end 220b of the external air inflow unit 220. In an embodiment, the mouthpiece unit 260 is a part that the user's mouth directly touches, and the user may inhale an aerosol generated in the aerosol generating system 10 through the mouthpiece unit 260.

In an embodiment, the aerosol generating device 200 may include at least two airflow paths. Referring to FIG. 2B, the aerosol generating device 200 may include a first airflow path f1 and a second airflow path f2.

In an embodiment, the first airflow path f1 may fluidly connect at least the medium accommodation portion 230, the external air inflow unit 220, and the mouthpiece unit 260. An aerosol generated by heating the medium accommodation portion 230 may flow to the mouthpiece unit 260 through the external air inflow unit 220. In an embodiment, the first airflow path f1 may further fluidly connect the airflow path tube 250. A fluid flowing in through a through hole (not shown) of the second end 210b of the housing 210 may sequentially pass through the aerosol generating article 400 accommodated in the medium accommodation portion 230 to the external air inflow unit 220 and the mouthpiece unit 260. In an embodiment, a flow of the fluid through the first airflow path f1 may correspond to a main flow delivering the aerosol of the aerosol generating system 10 to the user's mouth.

In an embodiment, the second airflow path f2 may include a flow of an external fluid introduced through the perforation 222 of the external air inflow unit 220. In an embodiment, a temperature of the fluid flowing through the second airflow path f2 may be lower than a temperature of the fluid flowing through the first airflow path f1. In an embodiment, the fluid flowing through the second airflow path f2 may include an external fluid around the aerosol generating system 10. In an embodiment, the second airflow path f2 may be perpendicular to the first airflow path f2. In an embodiment, the second airflow path f2 may form an oblique angle with the first airflow path 12.

In an embodiment, the external fluid flowing through the second airflow path f2 may be mixed with the fluid flowing through the first airflow path f1 inside the external air inflow unit 220. The fluid flowing through the second airflow path f2 may cool the fluid flowing through the first airflow path f1 to cause a phase change in the fluid. When the fluid flowing through the first airflow path f1 is a liquid, condensation may occur and the amount of aerosol may increase. When the fluid flowing through the first airflow path f1 is a gas, sublimation (which is conversion of a substance from a gaseous state to a solid state) may occur and the amount of aerosol may increase. Accordingly, the amount of aerosol flowing through the inside of the mouthpiece unit 260 may further increase. In an embodiment, a sensory evaluation result for the amount of aerosol, that is, a level of an atomization amount, generated when the user inhales the aerosol using the aerosol generating system 10 is as shown in Table 1. With regard to an electronic cigarette of the related art, evaluators expressed an average satisfaction level of about 4 points out of 7 points. In contrast, the satisfaction of the evaluators with the aerosol generating system 10 according to an embodiment was about 4.7 points, showing a significant difference. The sample size for the sensory evaluation is a total of 13 people.

TABLE 1

| | Electronic cigarette | Aerosol generating |
|---|---|---|
| | of related art | system 10 |
| Level of atomization | 4.0/7.0 | 4.7/7.0 |
| amount (1 to 7 points) | | |

In an embodiment, the display unit 270 (e.g., the display 132 of FIG. 1) may visually provide information about the aerosol generating device 200 to the user. The information about the aerosol generating device 200 may include, for example, a charging/discharging state of the battery 280 of the aerosol generating device 200, a preheating state of the heating unit 240, an insertion/removal state of the aerosol generating article 400, a limited usage state (e.g., an abnormal article detected) of the aerosol generating device 200, or the like, and the display unit 270 may externally output the information. The display unit 270 may be, for example, an LCD, an OLED, or the like. The display unit 270 may also be in the form of an LED device.

In an embodiment, the battery 280 (e.g., the battery 140 of FIG. 1) may supply power to be used to operate the aerosol generating device 200. For example, the battery 280 may supply power to heat the heating unit 240 and supply power required to operate the controller 290 (e.g., the controller 110 of FIG. 1). In addition, the battery 280 may supply power required to operate the display unit 270, a sensor (e.g., the sensing unit 120 of FIG. 1), a motor, or the like installed in the aerosol generating device 200.

In an embodiment, the controller 290 (e.g., the controller 110 of FIG. 1) may control the overall operation of the aerosol generating device 200. For example, the controller 290 may control power supplied to the heating unit 240 from the battery 280. The controller 290 may also control respective operations of other components included in the aerosol generating device 200, in addition to the battery 280 and the heating unit 240. In addition, the controller 290 may verify a state of each of the components of the aerosol generating device 200 to determine whether the aerosol generating device 200 is in an operable state. The controller 290 according to an embodiment may include a printed circuit board (PCB) 292 and a PCB frame 294. The PCB 292 may be seated inside the PCB frame 294 (see FIG. 2C).

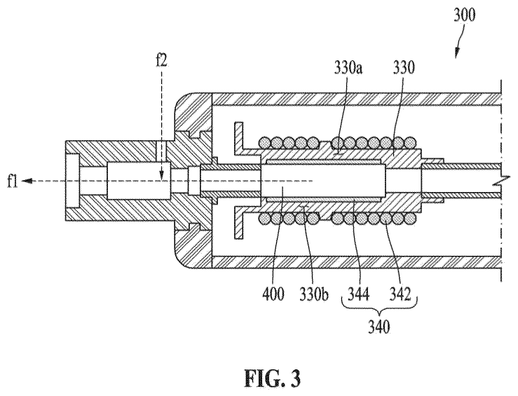

Hereinafter, the aerosol generating system 10 including an induction heating type heating unit 340 will be described in detail with reference to FIG. 3. In an embodiment, an aerosol generating device 300 (e.g., the aerosol generating device 200) may include all of the components according to the embodiment described above. The common components to those in the aerosol generating device 200 according to the embodiment described above have been described in detail with reference to FIGS. 2A to 2C, and therefore, the description thereof will be omitted hereinafter.

FIG. 3 is a cross-sectional view of an aerosol generating system (e.g., the aerosol generating system 10 of FIG. 2) according to an embodiment.

In an embodiment, the aerosol generating device 300 may include a medium accommodation portion 330 and the heating unit 340.

The medium accommodation portion 330 according to an embodiment may have a space in which the aerosol generating article 400 is accommodated. In an embodiment, the medium accommodation portion 330 may be disposed inside a housing (e.g., the housing 210 of FIG. 2A and/or FIG. 2C). In an embodiment, the medium accommodation portion 330 may include a first wall 330a and a second wall 330b facing the first wall 330a. In an embodiment, the medium accommodation portion 330 may accommodate the aerosol generating article 400. In an embodiment, the aerosol generating article 400 accommodated inside the medium accommodation portion 330 may be accommodated to fit tight inside the medium accommodation portion 330.

The heating unit 340 according to an embodiment may heat the aerosol generating article 400 accommodated inside the medium accommodation portion 330. The aerosol generating article 400 heated by the heating unit 340 may form an aerosol. In an embodiment, the heating unit 340 may be disposed in contact with outer surfaces of the first wall 330a and the second wall 330b of the medium accommodation portion 330. In an embodiment, the heating unit 340 may be disposed with a gap to be spaced apart from the outer surfaces of the first wall 330a and the second wall 330b of the medium accommodation portion 330. The heating unit 340 according to an embodiment may include an induction coil 342 and a susceptor 344. The heating unit 340 may heat the aerosol generating article 400 using an induction heating method. For example, the heating unit 340 may heat the aerosol generating article 400 using the susceptor 344, which is heated by generating heat through a variable magnetic field applied by the induction coil 342. In an embodiment, the induction coil 342 may be wound along outer walls of the medium accommodation portion 330, in which the aerosol generating article 400 is accommodated, to induce a variable magnetic field.

In an embodiment, the susceptor 344 may be disposed in contact with the outer surface of the first wall 330a and the outer surface of the second wall 230b of the medium accommodation portion 330. In an embodiment, the susceptor 344 may be disposed in contact with the outer surfaces of the first wall 330a and the second wall 330b to minimize a loss of heat generated in the heating unit 340.

In an embodiment, the susceptor 344 may be disposed on an outer surface of the aerosol generating article 400. When the susceptor 344 is disposed to surround the outer surface of the aerosol generating article 400, the heating unit 340 of the aerosol generating device 300 may not include the susceptor 344.

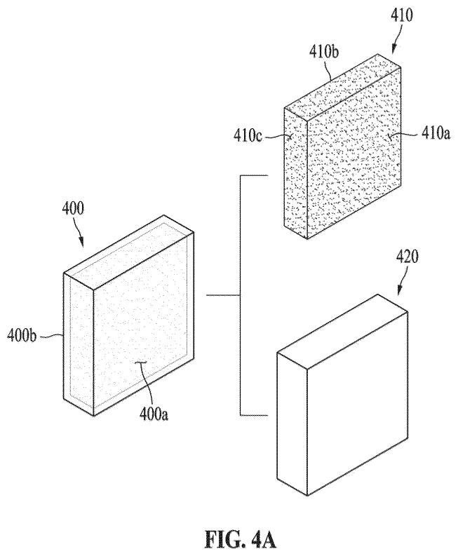

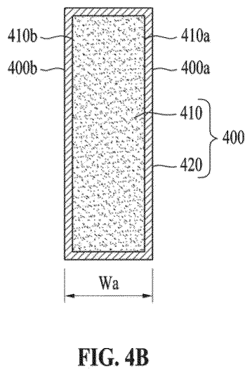

Hereinafter, the aerosol generating article 400 accommodated inside the aerosol generating system 10 will be described with reference to FIGS. 4A and 4B. FIG. 4A is a perspective view of the aerosol generating article 400 according to an embodiment. FIG. 4B is a cross-sectional view of the aerosol generating article 400 according to an embodiment.

In an embodiment, the aerosol generating article 400 may include a medium portion 410 and an outer cover portion 420. In an embodiment, the aerosol generating article 400 may include a first surface 400a and a second surface 400b formed on a side opposite to the first surface 400a. In an embodiment, the aerosol generating article 400 may be accommodated in a medium accommodation portion (e.g., the medium accommodation portion 230 of FIGS. 2A to 2C and/or the medium accommodation portion 330 of FIG. 3) of an aerosol generating device (e.g., the aerosol generating device 200 of FIGS. 2A to 2C and/or the aerosol generating device 300 of FIG. 3) such that the first surface 400a contacts with an inner surface of a first wall (e.g., the first wall 230a of FIG. 2A to 2C or the first wall 330a of FIG. 3) and the second surface 400b contacts with an inner surface of a second wall (e.g., the second wall 230b of FIG. 2A to 2C or the second wall 330b of FIG. 3). A heat loss may be minimized as both surfaces 400a and 400b of the aerosol generating article 400 are disposed in contact with the inner surfaces of the first wall (230a; 330a) and the second wall (230b; 330b) of the medium accommodation portion (230; 330). In an embodiment, a width (e.g., the width Wd of FIG. 2B) between the first wall (230a; 330a) and the second wall (230b; 330b) of the medium accommodation portion (230; 330) may be smaller than or equal to a width Wa between the first surface 400a and the second surface 400b of the aerosol generating article 400. The aerosol generating article 400 may be more firmly accommodated inside the medium accommodation portion (230; 330) by a difference between the width Wd of the medium accommodation portion (230; 330) and the width of the aerosol generating article 400.

In an embodiment, the medium portion 410 may include a first medium surface 410a, a second medium surface 410b formed on a side opposite to the first medium surface 410a, and one or more medium side surfaces 410c perpendicular to the first medium surface 410a and the second medium surface 410b.

In an embodiment, the outer cover portion 420 may cover at least one of the first medium surface 410a, the second medium surface 410b, and the medium side surfaces 410c of the medium portion 410. In an embodiment, the outer cover portion 420 may be formed of a porous material.

In an embodiment, the first surface 400a and the second surface 400b of the aerosol generating article 400 may have the same shape and area. In an embodiment, the first surface 400a and the second surface 400b of the aerosol generating article 400 may have a triangular shape. In an embodiment, the first surface 400a and the second surface 400b of the aerosol generating article 400 may have a rectangular shape. In an embodiment, the first surface 400a and the second surface 400b of the aerosol generating article 400 may have a pentagonal shape. In an embodiment, the first surface 400a and the second surface 400b of the aerosol generating article 400 may have a hexagonal shape. In an embodiment, the first surface 400a and the second surface 400b of the aerosol generating article 400 may have a circular shape.

In an embodiment, each area of the first surface 400a and/or the second surface 400b of the aerosol generating article 400 may be larger than an area of the side surface 400c. That is, the aerosol generating article 400 may have a wide and flat shape.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents of the claims are within the scope of the following claims.

1. An aerosol generating system comprising:
an aerosol generating device; and
an aerosol generating article accommodated in the aerosol generating device,
wherein the aerosol generating device comprises:
a housing comprising a first housing end and a second housing end on a side opposite to the first housing end;
an external air inflow unit detachably coupled to the first housing end of the housing;
a medium accommodation portion disposed in the housing and comprising a first wall and a second wall facing the first wall;
a heating unit disposed outside the first wall and the second wall of the medium accommodation portion and configured to heat the aerosol generating article accommodated in the medium accommodation portion; and
an airflow path tube fluidly connecting the medium accommodation portion and the second housing end of the housing, and
wherein the external air inflow unit comprises a perforation that causes external air of the aerosol generating device to flow into the inside of the aerosol generating device.

2. The aerosol generating system of claim 1, wherein
the aerosol generating article comprises:
a medium portion; and
an outer cover portion that covers outer surfaces of the medium accommodation portion, and
the aerosol generating article comprises a first surface that contacts with an inner surface of the first wall and a second surface that contacts with an inner surface of the second wall when the aerosol generating article is accommodated in the medium accommodation portion.

3. The aerosol generating system of claim 1, wherein the heating unit further comprises:
a susceptor surrounding at least two surfaces of the medium accommodation portion; and
an induction coil that induces a variable magnetic field to the susceptor.

4. The aerosol generating system of claim 1, wherein the heating unit is configured to contact with an outer surface of the first wall and an outer surface of the second wall of the medium accommodation portion to directly heat the aerosol generating article accommodated in the medium accommodation portion.

5. The aerosol generating system of claim 2, wherein a width between the first wall and the second wall of the medium accommodation portion of the aerosol generating device is smaller than or equal to a width between the first surface and the second surface of the aerosol generating article.

6. The aerosol generating system of claim 1, wherein the aerosol generating device further comprises:
a mouthpiece unit;
a first airflow path fluidly connecting the mouthpiece unit and the medium accommodation portion; and
a second airflow path fluidly connecting the first airflow path and the outside of the aerosol generating device.

7. The aerosol generating system of claim 6, wherein the external air inflow unit reduces a temperature of an aerosol as air introduced through the perforation moves along the second airflow path when a user inhales through the mouthpiece unit.

8. An aerosol generating article comprising:
a first surface, a second surface formed on a side opposite to the first surface, and one or more side surfaces perpendicular to the first surface and the second surface;
a medium portion comprising a first medium surface, a second medium surface formed on a side opposite to the first medium surface, and one or more medium side surfaces perpendicular to the first medium surface and the second medium surface; and
an outer cover portion covering the first medium surface, the second medium surface, and the medium side surfaces of the medium portion and formed of a porous material,
wherein the aerosol generating article is selectively transferred by a method in which the aerosol generating article is inserted into the medium accommodation portion of the aerosol generating device of claim 1 to be transferred through an aerosol generated by heating and a method in which the aerosol generating article is inserted into user's mouth to be directly transferred.

9. The aerosol generating article of claim 8, wherein the first surface and the second surface of the aerosol generating article have the same shape and area.

10. The aerosol generating article of claim 9, wherein each area of the first surface and the second surface is larger than an area of the side surface.
